(19) United States
(12) Patent Application Publication
(10) Pub. No.: US 2006/0040576 A1
(43) Pub. Date: Feb. 23, 2006

(54) Anti-penetration flexible composite material

(76) Inventor: Giorgio Celeste Citterio, Monza-Milan (IT)

Correspondence Address: James V Costigan;Hedman & Costigan, 1185 Avenue of the Americas, New York, NY, 10036-2601, US

(21) Appl. No.: 10/519,954

(22) PCT Filed: Oct. 20, 2003
(86) PCT No.: PCT/EP03/11645

§ 371 Date: Dec. 31, 2004

(30) Foreign Application Priority Data
Feb. 19, 2003 (IT) MI2003A000295

(51) Int. Cl. B32B 5/02; B32B 27/04; D03D 15/00; B32B 27/12

(52) U.S. Cl. 442/135; 442/59; 442/134; 442/181; 442/286

(57) ABSTRACT

The present invention relates to an anti-penetration flexible composite material, comprising a series of ballistic fibres arranged on one or more overlying layers, in which at least one portion of said fibres is impregnated with a resin or a polymer in the form of a viscous or visco-elastic liquid.

The present invention relates to an anti-penetration flexible composite material.

In particular, the present invention relates. to a high flexible composite material having high ballistic properties and very comfortable anti-ballistic articles, produced with this material.

Articles resistant to penetration generally consist of a series of overlying layers of particular ballistic fabrics.

It is known that ballistic fabrics are made with high tenacity and resistant fibres amongst which the aramidic, polyethylene or polybenzobisoxazole type are preferred.

The fibres can be arranged in different constructions, which are well known in the art such as the warp and weft structure to give a woven fabric or such as the uni, multi or semidirectional structures.

For the production of ballistic articles commonly used, such as jackets, body armour or bullet-proof vests, the above fibres are generally present in the form of weft-warp fabrics or unidirectional, semi-unidirectional, bi-axial or multi-axial fabrics.

It has been verified that in the ballistic structures, the anti-penetration effect and consequently the arrest of the bullet basically takes place in two phases:
in the first phase, the propagation of a shock wave occurs along the fibres of the surface layers of the ballistic fabric struck by the bullet. The propagation rate of the shock wave, and consequently the energy absorption mechanism, is directly correlated to the modulus of the fibre and to the sound propagation rate along the fibres themselves. This wave propagation phenomenon has a time duration in the order of micro-seconds and has the main purpose of deforming the bullet.
in the second phase, the ballistic structure deforms and adsorbs an additional part of energy.

In conventional ballistic weft-warp fabrics, in which the weft fibres cross the warp fibres, the shock waves along the same fibres are reflected in the interlacing points with the same direction and magnitude as the primary incident wave; the fibre consequently undergoes superimposed stress phenomena with a premature yielding of the structure.

A further disadvantage observed with the use of traditional ballistic fabrics is that the difference in involution of the warp yarn with respect to the weft yarn generally produces an unbalanced fabric which causes the non-homogeneous propagation of stress and elongations in the weft and warp directions.

In order to increase the ballistic properties, the weft-warp fabrics have been improved by sewing the overlying layers, for example as illustrated in American patent U.S. Pat. No. 5,619,748.

It was subsequently found that unidirectional fabrics have an enhanced ballistic behaviour with respect to weft-warp fabrics. This ballistic improvement is mainly due to the absence of interlacing points between the fibres thus reducing the shock wave reflection.

It has been found however that in unidirectional ballistic fabrics, the fibres tend to separate as a result of the impact of the bullet without contributing therefore to the stoppage of the bullet.

In order to prevent these drawbacks and consequently increase the anti-penetration performances of ballistic fabrics, resin finishing treatment is effected on the fibres.

The function of the resin is to allow the energy transfer between the fibrils of the fibres by means of delamination processes between fibril and resin. This consequently improves the energy absorption.

A typical example of a ballistic fabric of the weft-warp type with resin is described in American patent U.S. Pat. No. 6,127,291.

The use of another type of fabric for ballistic purposes, the so-called unidirectional fabric whose fibres are impregnated with a solid matrix which contributes to increasing shock-resistance, is also known, for example from American patent U.S. Pat. No. 4,173,138.

A unidirectional ballistic fabric having a polymeric matrix of an elastomeric nature, in particular made of Kraton, with a modulus lower than about 41,300 kPa, is also known from U.S. Pat. No. 4,623,574.

These fabrics however have the disadvantage of having a high structural rigidity due to the mechanical properties of the resin which forms an excessively rigid and uncomfortable ballistic body armour, above all if worn for long periods.

It has also been found that in the case of a firearm conflict, the movements of subjects wearing a bullet-proof vest made with rigid materials are restricted making them an easy target.

Attempts were therefore made to improve the flexibility of unidirectional fabrics by applying a series of creases or wrinkles on the external film made of polymeric material. This treatment also proved to be unsatisfactory with respect to the flexibility properties.

Various anti-penetration structures are also known, produced by the impregnation or lamination of the fabrics with suitable thermoplastic or thermosetting, elastomeric solid resins.

U.S. Pat. No. 5,090,053 discloses a composite shock absorbing material for use in impact absorbing bumpers, protective sporting equipment and in protective garments, comprising a open mesh array formed by a plurality of intersecting interconnected strands and a plurality of plies of said mesh secured in overlying relation, wherein each of said strands has a core surrounded by a viscoelastic polymer which preferably consists of sorbothane, a solid polymer. It disclosed that the composite material can be provided with a cooling system for fluid passages interconnected at each strand intersection the open mesh array of the composite is not suitable to stop bullets or knives it can be used only as trauma liner.

It is also known from U.S. Pat. No. 4,836,084 a hard armour plate composite comprising a hard impact layer based on ceramic material attached to a sub-layer laminate being formed by a laminate of alternating fiber layers and metal plates. The fibers in the sub-layer laminate are impregnated with a bonding synthetic solid material having viscloelastic properties. On a sample of the viscoelastic synthetic material used, the tangent of the loss angle δ, measured at 20° C. and at a frequency of 1 Hertz has the values 0.01<tangent 6<100 and the loss-shear modulus, in the same conditions, has the value 10² Pa<G″<10⁹ Pa. The disclosed armour plate composite is not flexible at all which results in a very rigid structure having a very low comfort.

It has been found however that the presence of these solid resins or matrixes in the ballistic end-article still creates an excessively rigid structure.

The necessity is therefore felt for ballistic materials or fabrics which combine satisfactory characteristics from a ballistic point of view with a high flexibility and comfort.

One of the general objectives of the present invention therefore consists in avoiding or reducing the incidence of some of the drawbacks of the ballistic articles of the known art, by providing an anti-penetration flexible composite material.

A further objective of the present invention consists in providing a ballistic article which is highly resistant to the penetration of bullets and sharpened bodies in general, with a high comfort of use.

A last but not least important objective of the present invention consists in providing a bullet-proof vest which is flexible and comfortable also when worn for long periods of time and with a high resistance to the penetration of sharpened bodies.

In view of these and other objectives which will appear more evident hereunder, a first aspect of the present invention relates to an anti-penetration flexible composite material comprising a plurality of ballistic fibres arranged on overlying layers, in which at least a portion of said fibres is impregnated with a polymer in the form of a viscous or visco-elastic liquid which maintains its fluid characteristics.

In the scope of the invention, the term polymer refers to both a polymeric material and also a natural or synthetic resin, and their mixtures.

It has been found that by applying or wetting a polymer in the form of a viscous or visco-elastic liquid to ballistic fibres, the final ballistic characteristics are increased and also the flexibility properties are improved. In particular, if the polymer used is a visco-elastic liquid, it is continuously deformed when subjected to share forces and tends to re-acquire its form in the absence of said forces. Advantageously, the used visco-elastic polymer, which is in liquid form, retains its fluid characteristics such that the anti-penetration flexible composite material of the invention remains permanently wetted by said polymer.

The term fibre generally refers to an elongated body whose length is much greater than its transversal section. In particular, ballistic fibres comprise those fibres which are used for producing materials, fabrics, end-products and articles having a resistance to the penetration against bullets, cutting blades, screwdrivers, bayonets and any object generally having a pointed or sharpened form.

Examples of ballistic fibres which can be used within the scope of the invention include fibres based on polyvinyl alcohol, polyacrylonitrile, polybenzobisoxazole (PBO), polyolefinic, polimidic, polyaramidic, polyamidic, carbon or glass fibres and their mixtures.

Preferred ballistic fibres for the purposes of the invention are selected from aromatic polyamidic fibres (aramidic fibres), polyethylene fibres, polybenzobisoxazole (PBO) fibres and their mixtures.

Within the scope of the invention, the use of polyaramidic fibres is particularly preferred, as they have a high tenacity, conveniently equal to or higher than the value of 2,000 MPa.

Within the scope of the invention, the use of ballistic fibres having an impact strength equal to at least 15 J/g, a modulus of at least 200 g/dtex, a breaking strength of at least 10 g/dtex, a count from 50 to 5,000 dtex and a count of the fibrils ranging from 0.5 to 20 dtex, is also advantageous.

The fibres used in the flexible composite material of the invention can typically be in an impregnated, noncoated form, or they can be coated by other materials, for example polymeric materials. Typically, the fibres can be previously pre-treated, for example, pre-stretched, preheated or pre-wetted.

According to an aspect of the invention, the ballistic fibres of the material of the invention are arranged in one layer and preferably in a plurality of overlying layers forming an anti-penetration multi-layer structure.

In the composite material of the invention, the ballistic fibres can be arranged in different constructions, for example as a fabric of the unidirectional or multidirectional type, as a warp west fabric, as a semi-unidirectional or semi-multidirectional fabric in which at least 70% by weight of the fibres in the structure are aligned with the same direction, as a heddle fabric, as bi-axial or multi-axial fabric, as non-woven fabric, or as a felt.

The layer of fibres can be made by means of different operating procedures, for example by traditional weft-warp looms, multi-axial looms, knitting looms, or unidirectional or bi-directional looms, needle-puncture machines, and other textile machines known to persons skilled in the art. It is also possible to use mixed techniques using one or more of the above machines.

In accordance with an embodiment of the invention, the composite material is in the form of a fabric preferably of the multi-axial type, in which the fibres have a high impact strength. The weight of these fabrics typically ranges from 0.05 to 0.9 Kg/m² and preferably from 0.07 to 0.5 Kg/m², values which allow a favourable ratio to be obtained between penetration resistance and weight.

The ballistic protection can be conveniently increased by the superimposition of two or more network layers of fibres or by the superimposition of layers of fabric with different constructions.

According to another embodiment, the layers of fibres can be sewn together in a series of layers or connected to each other with various connection means, for example by resorting to the use of cross-linkable plastomeric, elastomeric or thermosetting crosslinkable resins or polymers or their mixtures, for example in the form of films, felts or powders.

The layers of overlying fibres can be arranged at random or along predefined directions and angles with respect to the main direction of the fibres.

In the composite material of the invention, the ballistic fibres, or at least a portion thereof, are placed in contact or impregnated with a polymer in the form of a viscous, conveniently visco-elastic liquid which maintains its fluid characteristics, conveniently at all the working temperatures.

The term visco-elastic liquid refers to a liquid which has both an elastic and viscous behaviour.

Viscous behaviour means that the liquid medium undergoes continuous deformation when subjected to shear stress and remains deformed even when the stress is no longer applied.

Elastic behaviour means that the liquid medium undergoes deformation when subjected to shear stress and then returns to the original form when the stress is no longer applied.

The material parameters used to describe a viscous or visco-elastic liquid are viscosity (with respect to the viscous behaviour) and elastic modulus (G′) and the loss of elastic modulus (G″) to describe the visco-elastic behaviour. The viscosity and modulus in a polymer are generally correlated to the shear rate, molecular weight, temperature, pressure, crystallinity, concentration and composition.

The dynamic viscosity of the fluid polymer used within the scope of the invention is advantageously greater than 250 mPa×s, and preferably ranges from 5,000 to 500,000 mPa*s and more preferably from 50,000 to 25,000,000 mPa*s at 25° C. Preferably, a kinematic viscosity of the fluid polymer used with the scope of the invention is advantageously grater than 200 cST.

Another characterisation of a viscous or visco-elastic liquid is its glass transition temperature, hereunder called Tg.

The liquid polymer used within the scope of the invention conveniently has a Tg lower than 0° C., and preferably ranges from −40° C. to −128° C.

The liquid polymer suitable for the present invention is preferably chemically stable, stable to light, to degradation by the environment, not subject to spontaneous polymerization, not harmful for the health, hydrophobic, and conveniently has a negligible vapour pressure at mild temperatures (20-40° C.). Furthermore, the polymer of the invention conveniently maintains a high viscosity index correlated to the temperature.

It has been verified that the partial or total impregnation of a fibre with said polymer in the form of a viscous or visco-elastic liquid allows each filament of the fibres to slip on the adjacent filaments. This characteristic improves the flexibility of the network of ballistic fibres and unexpectedly increases the ballistic properties of the composite material of the invention.

According to a preferred embodiment of the invention, the liquid polymer has a liquid behaviour also at temperature lower than −40° C. and preferably up to −128° C. and has G″>G′, conveniently at all the temperatures and frequencies.

In accordance with an aspect of the present invention, a fibre is thus provided, which is in contact or impregnated or wetted with a polymer in the form of a viscous or visco-elastic liquid suitable for ballistic purposes.

According to another aspect of the invention, a flexible ballistic composite material is provided, which comprises a series of said ballistic fibres put in contact or impregnated with a polymer in the form of a viscous liquid or visco-elastic liquid.

In the ballistic composite material of the invention, the ballistic fibres can be completely coated or impregnated with said liquid polymer or they can be only partially coated or impregnated.

The coating of the ballistic fibres or portions thereof with the liquid polymer of the invention can be conveniently effected before the realization of the network of fibres or is preferably the sizing agent of the fibres. This means that the liquid also acts as a spinning and weaving coadjuvant, i.e. as a finishing agent.

According to an embodiment, the viscous or visco-elastic liquid can be dissolved in a suitable dissolving medium in order to control its viscosity before being applied to the fibres. The coating can be effected in various ways: for example by dipping the network of fibres in the liquid polymer, or alternatively the liquid polymer can be sprayed onto the surface through nozzles.

Another possibility is to impregnate the network of fibres by passing it above a rotating cylinder wet by the liquid polymer.

If the liquid has been previously diluted with a solvent, then the solvent is conveniently evaporated before subjecting the network of fibres to possible additional process.

The network of impregnated fibres can then be further processes by subjecting it to pressure and temperature.

Temperatures from −200 to 2000 and preferably from 100° C. to 145° C., and pressures from 0.1 Bar to 200 Bar, are conveniently adopted, in times from 0.1 to 30 minutes. Longer times may be necessary for special applications, for example using the material for rigid ballistic composites.

The network can be subjected to temperature and pressure before and or after impregnation.

According to another embodiment, fillers can be added to the viscous or visco-elastic liquid polymer, in the form of particles or similar, such as for example metallic powders, mineral-based powders, for example silicon carbide, calcium carbonate, silicon, silicon dioxide, micro-balloons, whiskers, in a quantities ranging, for example, from 0.1 to 300% by weight with respect to the weight of the resin.

One or more thickening agents can also be added to the viscous liquid polymer in order to modify the viscosity profile or provide thixotropy. To cite an example, polymers can be used which modify the viscosity, such as block polymers, paraffinic oils, waxes and their mixtures. It is also possible to add to the liquid polymer other substances suitable for providing specific characteristics to the network of fibres such as hydro-oil repellency, such as silicones, fluorocarbons and oils. The fillers and other polymers added must not however vary the physical state of the polymer of the invention.

It has been verified that the application of a viscous or visco-elastic liquid polymer to ballistic fibres unexpectedly increases the ballistic characteristics and at the same time their flexibility.

Polymers or resins in the form of a viscous or visco-elastic liquid which are suitable for the purposes of the invention comprise polyolefins, in particular polyalpha-olefins or modified polyolefins (among which polyethylene, polypropylene), polyvinyl alcohol derivatives, polyisoprenes, polybutadienes, polybutenes, polyisobutylenes, polyesters, polyacrylates, polyamides, polysulfones, polysulfides; polyurethanes, polycarbonates, polyfluoro-carbons, silicones, glycols, among which polypropylene and polyethylene glycol; liquid block copolymers such as polybutadiene-co-acrylonitrile, polystyrene-polybutadiene-polystyrene, ethylene co-polypropylene, resins among which polyacrylic, epoxy, phenolic resins, optionally modified, and liquid rubbers.

Particularly suitable fluid polymers advantageously have a molecular weight higher than or equal to 250, preferably ranging from 250 to 50,000 and however such as to maintain the fluid state and a high viscosity.

Particularly suitable fluids within the scope of the invention are non-Newtonian liquid fluids, also thixotropic and preferably visco-elastic liquids.

In the composite material of the invention, the polymer in the form of a viscous or visco-elastic liquid is present in quantities, conveniently ranging from 0.05% to 50% by weight with respect to the weight of the ballistic fibres and preferably from 5 to 30% by weight, with respect to the weight of the fibres.

The characteristics of a liquid polymer based on polybutene which can be used for the purposes of the present invention will appear more evident from the following illustrative but non-limiting description, referring to the enclosed schematic drawings.

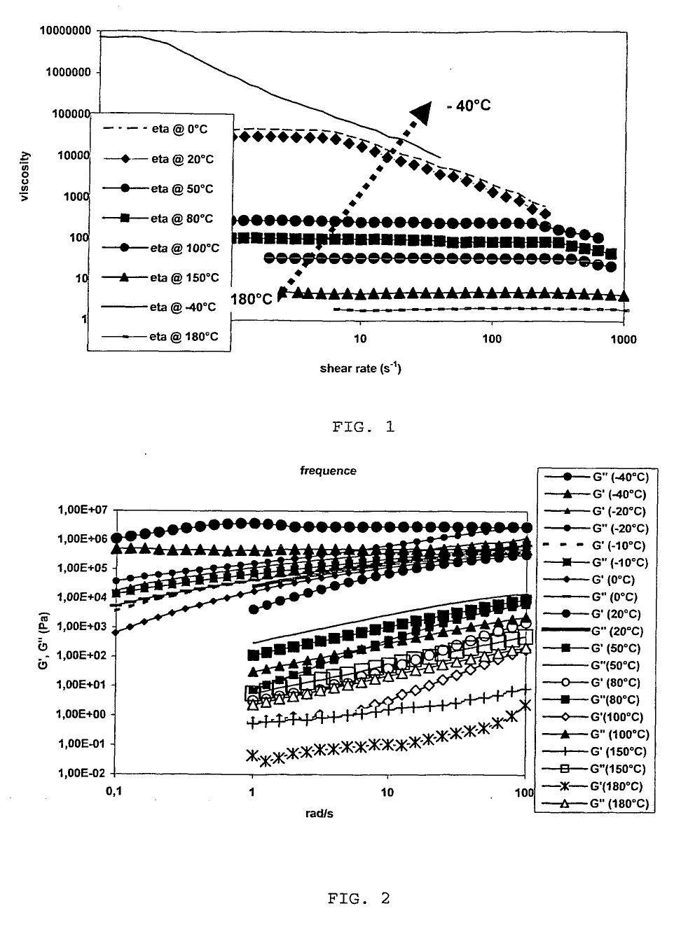

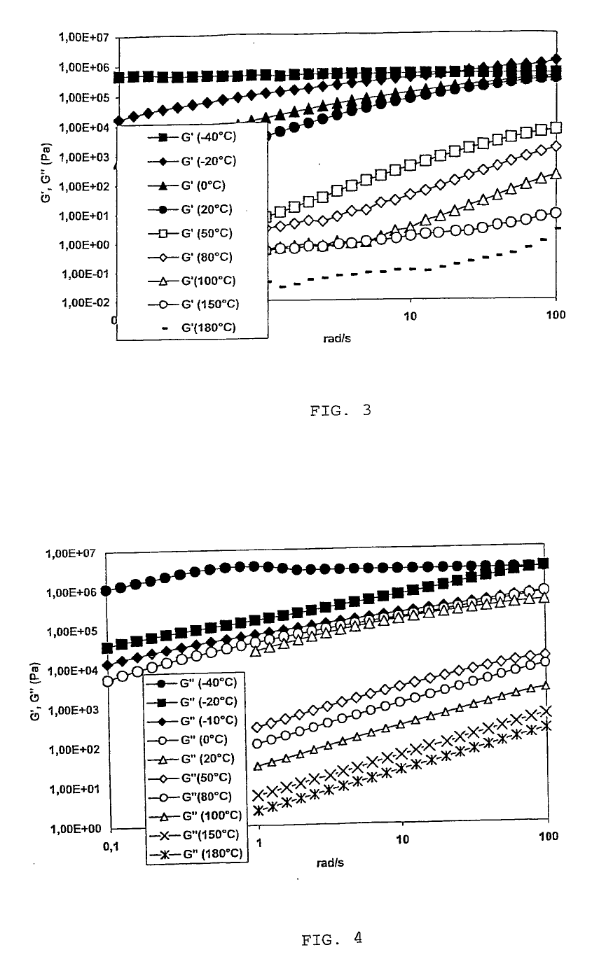

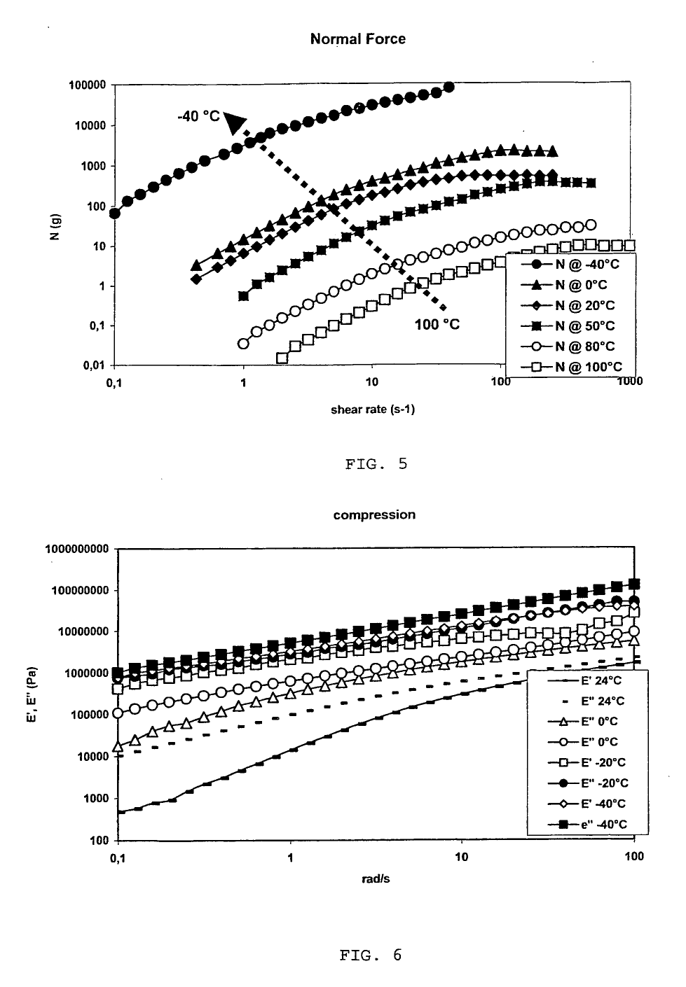

In particular, the rheological behaviour of the polybutene-based fluid polymer depends on the shear rate (deformation rate), the frequency of load application and the temperature, according to the following preferred characterization:
from 100° C. to 180° C. the liquid, if subjected to a shear flow, shows Newtonian behaviour, i.e. characterized by a constant dynamic viscosity value (ratio between the stress applied and the deformation rate) up to shear rates close to 900 s⁻¹, as illustrated in FIG. 1. With shear rates higher than 900 s⁻¹, the liquid shows a slight reduction in the viscosity (pseudo-plastic behaviour). (FIG. 1 indicates the viscosity values measured in relation to the temperature with two distinct shear rates (1 and 900 s⁻¹)). High normal force values N (component of the force which acts perpendicularly with respect to the direction of the flow) were not measured within this temperature range (illustrated in FIG. 5, N<1 Pa). In the same temperature range, the elastic modulus (G′) and the dissipative modulus (G″) have a behaviour which reveals the predominance of the liquid/viscous behaviour with respect to the elastic modulus (G″>G′) at all the frequencies illustrated in FIGS. 2, 3 and 4; the data relating to the elastic modulus (E′) and the dissipative modulus (E″), obtained from compression measurements, also confirm the prevalently viscous nature of the liquid in question, as illustrated in FIG. 6.
from 99° C. to −40° C. the behaviour is decidedly non-Newtonian of the strongly pseudo-plastic type i.e. such that the viscosity decreases with an increase in the shear rate, as appears from FIG. 1. In this temperature range, high normal forces (N) were measured indicating how the visco-elastic behaviour (which appears with the Weissemberg or rod climbing effect) increases with a decrease in the temperature, as illustrated in FIG. 5. In spite of the high viscosity and high normal force, however, the sample, up to a temperature of −40° C., always shows the prevalence of the dissipative component with respect to the elastic component both in the shear flow measurements (G″>G′, as demonstrated in FIGS. 2, 3 and 4) and in the compression measurements (E″>E′, illustrated in FIG. 6). This result explains the capacity of dissipating energy which the liquid maintains, also under low temperature and/or high frequency conditions (time/temperature inversion principle).

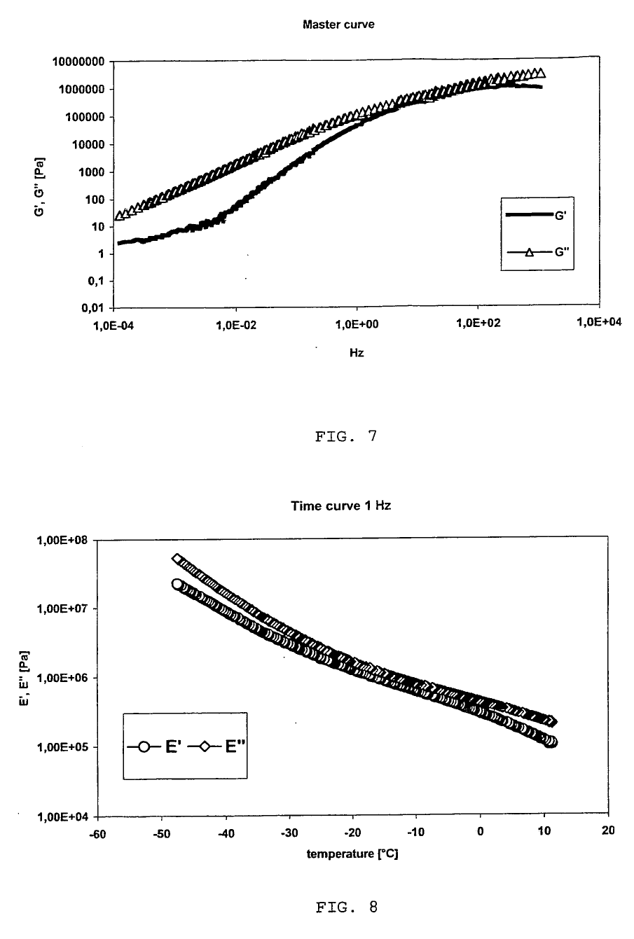

According to the time/temperature inversion principle, the high frequency behaviour was obtained (from 0.01 Hz to 8,000 Hz) at 25° C., as illustrated in FIG. 7, using the data obtained from the frequency shift at different temperatures (see FIGS. 2, 3 and 4). FIG. 8 illustrates the trend of the elastic component E′ and dissipative component E″ with a variation in the temperature, applying loads at a frequency of 1 Hz.

An extremely useful fabric for the purposes of the present invention is preferably obtained on a multi-axial loom and is made up of two or more layers of ballistic fibre interconnected by a polymeric film and optionally sewing threads.

In this specific case, the fabric is bi-axial and has been made preferably with 1100 dtex aramidic yarn; during the deposition phase of the ballistic threads a polymeric film is conveniently inserted between the two adjacent layers of the threads themselves. The fabric is advantageously stabilized by means of sewing threads which bind the two layers of ballistic fibres and subsequently is worked by calendering and impregnated by a liquid polymer and pressed with temperature. Typical pressure values during the calendering range from 5 to 50 bar, typical temperature values range from 75 to 150° C. in relation on the type of polymer inserted between the two layers of fibres.

Preferably, the values obtained by the impregnation are in a quantity ranging from 10 to 30 g/m²; an optional subsequent pressure applied on the fabric impregnated with liquid polymer, conveniently effected at 5/10 bar, homogenizes the distribution of the liquid polymer onto the fabric.

The weight of the finished fabric is typically about 500 g/m².

Another type of fabric useful for the purposes of the present invention is obtained on traditional warp and weft looms Fabrics having 10 warp threads and 9,7 weft threads, for a total weight of about 190 gr m² are also realized.

After weaving, the fabric is impregnated by total immersion in the liquid polymer, object of the present invention, with a quantity of about 20 gr m².

The process ends with a calendaring which is effected on hot rolls at 100° C. with a pressure of 1 bar.

In a second embodiment, the fabric is made on traditional weft-warp looms, as untraditional semi-unidirectional fabric, impregnated with liquid polymer and subsequently optionally pressed under heat.

In another embodiment of the present invention a film comprising a polymer selected from thermoplastic, thermosetting, elastomeric, crosslinkable or mixtures thereof, can be laminated on the surfaces of the fabric wet with the liquid resins by means of heat and temperature.

In a subsequent embodiment, the fabric is made up of two or more overlying layers of unidirectional or semi-unidirectional fibres (with an interlacing point angle typically ranging from 80 to 1000), between which a polymeric film is inserted; the fabric is treated with the liquid polymer of the invention and calendered and/or pressed.

According to another aspect of the present invention, body armour is provided, in particular a bullet-proof vest, made with the ballistic composite material as described above.

According to another aspect protective end-products or articles are provided, comprising the ballistic composite material of the invention.

The following examples are provided for purely exemplary purposes of the present invention and should in no way be considered as limiting its protective scope as specified by the enclosed claims.

### EXPERIMENTAL PART

In order to define the flexibility of a network of ballistic fibres, a flexibility index was defined according to the following test: two flat horizontal surfaces are placed on top of one another, each being connected on one side by a zip. The dimension of the surfaces is equal to 660×50 mm.

The above surfaces are supported by a vertical structure which crosses the horizontal surfaces on one side of the orientation surface.

The network of fibres having dimensions of 400×400 mm is inserted between the two horizontal surfaces with one side parallel to the side of the horizontal surface. The distance from the side of the fibre network to the first side of the horizontal surface is equal to 100 mm.

The flexibility index is the ratio of the horizontal distance of one side of a non-folded panel from the vertical surface and the distance of a folded panel from the vertical surface.

The impact of the bullet induces a deformation of the ballistic protection in the rear side whose value is inversely correlated to the quantity of energy absorbed by the protection itself. The values of these deformations are taken in a plasticine in a way well known to the person skilled on the art.

A greater energy absorbed by the protection corresponds to a lesser energy transferred to the wearer of the vest.

The rheological properties of the liquid were studied using two different rheometers:
rotational deformation control rheometer RMS800 of Rheometric Scientific for the measurements carried out applying a shear deformation field;
rheometer for dynamic mechanical measurements RSA2 of Rheometric Scientific, for “compression” measurements.

The measuring systems (measurement geometries) were:
for the shear measurements (rheometer RMS800), parallel plates were used (diameter 50 mm, 25 mm and 8 mm with a vertical gap ranging from 1.5 to 3 mm);
for the “compression” measurements (rheometer RSA2), a parallel plate geometry was used, with a diameter of 25 mm.

The experiment was carried out with variations in:
the shear rate from 0.1 to 1000 s⁻¹
the frequency from 0.1 to 100 rad/s (1 rad/s=1 Hz),
the temperature from −40° C. to 180°C.

The use of the two instruments for studying the rheological properties of the liquid is due to the possibility of simulating the stress to which the liquid is understandably subjected during its normal “activity”. Further information as to the technical information and instruments useful for measuring the viscosity are available from the publication Laboratorio 2000, November 2001 (strumenti per la misura della viscosità) which is hereby incorporated by reference.

### Example 1

The ballistic panel was prepared by superimposing 8 layers of +/−45° biaxial fabric, an aramid 1100 dtex was used as ballistic yarn.

A non-ballistic yarn was used to keep the fibres correctly aligned in each single layer.

Amongst the unidirectional aligned fiber of each layer resides an elastomeric film. After calendering the network of fibres was coated with a polybutene based viscous liquid (TEXTOL® by Lamberti Spa, Ardizzate, Mich.) which coats the remaining portion of the fibres not coated by the elastomeric film.

The weight for each layer was 475 g/m².

The total weight was 3,8 kg/m².

The main properties of the viscous liquid fluid are the following:

| | | |
|---|---|---|
| molecular weight | 5900 | |
| Kinematic viscosity | 1.000.000 | centistokes |
| (1.000.000 mPa · s) at 25° C. | | |
| Pour point | −60° | C. |
| Tg | −40° | C. |

The index of foldability or flexibility index for each layer was 0.400.

The index of foldability or flexibility index for the pack was 0.433.

The ballistic test was carried out following NIJ 01.01.003 class II shooting with 0.357 158 grs SJSP bullet. No perforation occurred. The registered trauma in the plasticine was 34 mm.

### Example 2

The same network of example 1 was used with the only difference that the coating was made with an (acrylic) elastomeric polymer available on the market which have showed good ballistic performances.

The characteristics of the acrylic elastomer are the following:

| | |
|---|---|
| strength (DIN 53455) | 1.86/mm² |
| elongation at break | 522% |
| TG | −30° C. |

The index of foldability for each single layer was 0.480;

The index of foldability for the pack was 0.581

The ballistic test was carried out following NIJ 01.01.003 for the class II shooting with 0.357 158 grs SJSP bullet.

No perforation occurred. The registered trauma in the plasticine was 34 mm.

### Example 3

23 layers of aramidic based warp and wefts fabric named as Style 802 (8.5 treads/cm in warp and 8.5 treads/cm in weft—count 1100 dtex—weight 190 g/m² in loom state) were impregnated with 7 g/m² of polybutene viscous liquid fluid as per example 1.

The index of foldability for each single layer was 0.127; The index of foldability for the pack was 0.133.

The ballistic pack was made by simple superimposition of the said 23 layers. Total weight was 4,530 kg/m² The ballistic test was carried out following NIJ 01.01.003 for the class II shooting with 0.357 158 grs SJSP bullet.

No perforation occurred. The registered trauma in the plasticine was 41 mm.

### Example 4

24 layers of aramid based warp and wefts fabric named Style 802 (8.5 treads/cm in warp—8.5 treads/cm in weft—count 1100 dtex—weight 190 g/m² in loom state) were impregnated with 7 g/m² of liquid viscous fluid as per example 1.

The index of foldability for each layer was 0.127.

The index of foldability for the pack was 0.133.

The ballistic pack was made by superimposition of said 24 layers of fibres. Total weight was 4,728 kg/m² The ballistic test was carried out following NIJ 01.01.003 for the class II shooting with 0.357 158 grs SJSP bullet.

No perforation occurred. The registered trauma in the plasticine was 36 mm

### Example 5

24 layers of the same aramid based warp and weft fabric Style 802 (8.5 treads/cm in warp and 8.5 treads/cm in weft—count 1100 dtex—weight 190 g/m²) loom state were superimposed, without impregnation.

The panel was central cross stitched with two small stitches of 50 mm. each. The weight was 4,560 kg/m².

The index of foldability for the pack was 0.233

The ballistic test was made as per example 3.

The test failed because the trauma exceeded the limits.

### Example 6

24 layers of the aramid based warp and weft fabric Style 802 (8.5 threads/cm in warp and 8.5 threads/cm in weft; count 1100 dtex; weight 190 g/m² in loom state.

The pack was made by superimposing 24 layers and subsequently and stitching with two periferical sewing with aramid yarn.

The index of foldability for the pack was 0,743.

Total weight 4,560 kg/m² were used

The test was carried out as per example 3. The registered trauma was 43 mm.

### Example 7

24 layers of the aramid based warp and weft fabric Style 802 (8.5 threads/cm in warp and 8.5 threads/cm in weft; count 1100 dtex; weight 190 g/m²) were superimposed without impregnation.

The pack was sewn in a pattern of 40×40 mm with aramid yarn at 45° degrees in respect to the direction of the ballistic fibres.

The index of foldability of the pack was practically infinite.

The ballistic test was carried out following NIJ 01.01.003 shooting with 0.357 158 grs SJSP bullet. No perforation was registered. The trauma was 39 mm.

### Example 8

22 layers of semi-unidirectional fabric were impregnated with the same viscous liquid used in example 1.

The fabric is made with aramid yarn 930 dtex. A plastomeric film was inserted between the two substrates making the single layer.

The two substrates have the ballistic fibres forming an angle of about 90°.

The pack was made by superimposition of the said 22 layer to achieve a total weight of 4,950/kg per square meter.

The index of foldability for each layer was 0.307.

The index of foldability of the pack was 0.373.

The ballistic test was carried out following the NJY 01.01.003 with class III A with a 0,44 Magnum caliber SJSP bullet. No penetration occurred and the trauma was 41.

### Example 9

23 layers of the same fabric of example 8 but without any impregnation were superimposed to produce the ballistic pack. The measured total weight was 5,065/kg per square meter.

The index of foldability for each layer was 0.233

The ballistic test was carried out following NIJ 01.01.003 class III A with a 0,44 Magnum caliber SJSP bullet. The test failed because the trauma exceeded the requirements of the specifications.

### Example 10

22 layers of semiunidirectional fabrics as per example n° 8 were coated with a viscous liquid fluid as per example n° 1.

The total weight was 5.065 m².

The index of foldability of each layer was 0.307.

The index of foldability of the pack was 0.373.

The ballistic test was carried out following NIJ 01.01.003 for the class II with 0.357 Magnum caliber SJSP bullet. No perforation was registered. The trauma was 38 mm.

### Example 11

22 layers of the same fabric described in example 8 were wetted by an acrylic elastomeric polymer which is well known to be a very performing matrix (as per example n.2) in ballistic construction. The layers were superimposed.

The quantity of polymer was 10 g/m² The total weight was 5,130 kg/m².

The index of foldability for each layer was 0.500.

The index of foldability of the pack was 0.443.

The test was carried out following NIJ 01.01.003 class II with a 0,357 Magnum caliber SJSP bullet. No penetration occurred and the trauma was 38 mm.

### Example 12

A unidirectional construction with layer crossing at 90° and weighting 263 g/m² was made with 1100 dtex aramide fibres. A polyethylene film lied between the unidirectional sub-layers.

17 layers of the above construction where partially coated with 8 g/m² of the same viscous liquid polymer as per example 1 and then superimposed each to another.

The total weight was 4,470 kg/m².

The index of foldability of each single layer was 0.447

The index of foldability of the pack was 0.383.

The pack was tested in order to find the ballistic limit with 9 mm FMJ bullet DM 11A₁B₂.

We found that the V 50 limit was 475 m/sec.

### Example 13

The textile construction as per example 12 was impregnated by using a thermoplastic elastomer named Kraton D-1161 (replacing Kraton D-1107 but having similar mechanical features) which is well known to be a very performing matrix in Ballistic Construction. The quantity of resin was 7 g/m².

17 layers were superimposed. The total weight was 4.488 kg/m².

The index of foldability for the single layer was 0.717.

The index of foldability of the pack was 0.740.

The stratification was tested in order to achieve the limit of the perforation rate with a projectile of 9 mm.

The ballistic limit found was 473 m/sec.

### Comparison Between Example 1 and Example 2

By coating the same number of layers of biaxial fabric with a viscoelastic liquid or with a elastomeric solid polymer it is founded:

Foldability is greater when the viscoelastic liquid is applied (0.400 compared to 0.480).

The ballistic properties does not change.

### Comparison Between Example and Example 5

By comparing a warp-weft fabric coated with a viscoelastic liquid to a non warp-weft fabric coated it is founded:

The foldability index is greater when a viscoelastic liquid is applied (0.127 compared to 0.233).

The ballistic properties are superior when the liquid is applied to (the non coated panel failed the test related to the trauma) even with inferior total specific weight.

### Comparison of Example 4, 6 and 7

By comparing the ballistic performance of a warp-weft fabric impregnated by a polybutene liquid of the invention to a non-impregnated warp weft fabric, having layers jointed by central, peripheral or quilt stitching, it is founded that the foldability index is greater when the viscoelastic liquid is applied (0.127 compared to 0.743 and 15).

In addition, ballistic properties are superior when the liquid is applied; the trauma is of 36 mm vs. 43 mm in the peripheral stitched fabric, of 39 mm in the quilt stitched fabric and of 44 mm in the central stitched fabric.

### Comparison Between Examples 8 and 9

By comparing a semi-uni-weave fabric coated with a viscoelastic polymeric liquid such as polybutene wit the same uncoated fabric it is founded:

Foldability index is comparable (0.307 compared to 0.233) when viscoelastic liquid fluid is applied and the ballistic properties are superior when the polymeric liquid is applied (the non coated panel failed the test related to the trauma) even with inferior total specific weight.

### Comparison Between Example 10 and Example 11

By comparing a semi-uniweave fabric coated with a viscoelastic polymeric (polybutene) liquid to the same fabric coated with an elastomeric polymer in solid form, it is founded that the foldability is greater when the viscoelastic liquid is applied (0.307 compared to 0.500); the ballistic properties related to trauma are the same (38 mm. for both the solutions).

### Comparison Between Example 12 and Example 13

By comparing a bi-axial fabric composition impregnated with a viscoelastic liquid to the same fabric coated with an elastomeric polymer in solid form, it is founded:

Foldability is greater when the viscoelastic liquid is applied (0.447 compared to 0.717).

Ballistic properties related to V₅₀ are practically the same (475 m/sec and 473 m/sec)

The foregoing is an evidence that by wetting or impregnating a plurality (network) of ballistic fibres with a visco or visco-elastic liquid according to the invention, the flexibility and ballistic properties are improved.

What we claim is:

1. An anti-penetration, flexible ballistic composite material comprising a plurality of ballistic fibres arranged on overlying layers, wherein at least a portion of said fibres is impregnated with a polymer in the form of a viscous or visco-elastic liquid.

2. The flexible composite material according to claim 1, wherein said polymer is a non-Newtonian visco-elastic liquid.

3. The ballistic composite material according to claim 1, wherein said polymer is in form of a visco-elastic liquid, wherein the dissipative component is greater with respect to the elastic component G″>G′.

4. The ballistic composite material according to claim 1, wherein said polymer has a dynamic viscosity ranging from 250 to 25,000,000 mPa·s at 25° C.

5. The ballistic composite material according to claim 1, wherein said polymer has a molecular weight ranging from 250 to 50,000.

6. The ballistic material according to claim 1, wherein said polymer has a kinematics viscosity higher than 200 cST at 25° C.

7. The ballistic composite material according to claim 1, wherein said polymer is selected from the group consisting of polyolefins, polyvinyl alcohol derivatives, polyisoprenes, polybutadienes, polybutenes, polyisobutylenes, polyesters, polyacrylates, polyamides, polysulfones, polysulfides; polyurethanes, polycarbonates, fluoro-carbons, silicones, glycols, liquid block copolymers, polyacrylic, epoxy, phenolic, liquid rubbers and their mixtures.

8. The ballistic composite material according to claim 1, wherein said polymer is in liquid form at a temperature lower than −128° C.

9. The ballistic composite material according to claim 1, wherein said polymer is a liquid with a thixotropic behaviour.

10. The ballistic composite material according to claim 1, wherein the fibres are arranged in a form selected from weft-warp fabric, unidirectional structure, semi-unidirectional structure, multi-directional structure, semi-multidirectional structure, bi- or multi-axial structure or combinations thereof.

11. The ballistic composite material according to claim 1, wherein said ballistic fibres are selected from the group consisting of polyvinyl alcohol, polyacrylonitrile, polyethylene, polybenzobisoxazole (PBO), polyimidic, polyaramidic, polyamidic, heterocyclic aramide, carbon or glass fibres and mixtures thereof.

12. The ballistic composite material according to claim 1, wherein the strength of said ballistic fibres is at least 15 g/den.

13. The ballistic composite material according to claim 1, wherein the modulus of said ballistic fibres is at least 200 g/den.

14. The ballistic composite material according to claim 1, wherein the energy to break of said ballistic fibres is at least 10 joules/g.

15. The ballistic composite material according to claims 1, wherein the count of said ballistic fibres ranges from 50 to 3,000 dtex and/or the count of each fibril ranges from 0.5 to 20 dtex.

16. The ballistic composite material according to claim 1, wherein a portion of said ballistic fibres is in contact with a thermoplastic, thermosetting, elastomeric, cross-linkable polymer and their mixtures.

17. The ballistic composite material according to claim 1, wherein at least a portion of said ballistic fibres is impregnated with said polymer in the form of a viscous or visco-elastic liquid.

18. The ballistic composite material according to claim 1, further comprising a polymeric film between or outside one or more of the layers of ballistic fibres.

19. The ballistic composite material according to claim 18, wherein said polymeric film comprises a polymer or a resin, each of which can be independently thermoplastic or thermosetting, crosslinkable, elastomeric and mixtures thereof.

20. The ballistic composite material according to any of the claim 1, wherein at least two layers of fibres are bound to each other by means of connecting means.

21. The ballistic material according to claim 20, wherein said connecting means comprise yarns or monofilaments.

22. The ballistic material according to claim 1, wherein the polymer in liquid form is polybutene.

23. Body armour comprising a ballistic composite material according to claim 1.

24. The body armour according to claim 23, consisting of a bullet-proof vest.

25. A process for preparing an anti-penetration flexible ballistic composite material which comprises the application of a polymer in the form of a viscous or viscoelastic liquid on at least a portion of said ballistic fibre.

26. The process according to claim 25, comprising the weaving of ballistic fibres, the impregnation of the fabric produced with a viscous or visco-elastic liquid polymer and the calendaring of the impregnated fabric.

27. The process according to claim 25, wherein the yarn is impregnated with a liquid polymer before the weaving and calendaring phase.
